(19) United States
(12) Patent Application Publication
(10) Pub. No.: US 2010/0213727 A1
(43) Pub. Date: Aug. 26, 2010

(54) HANDLING CLAW

(76) Inventor: Gregor Laese, Niedernhausen (DE)

Correspondence Address: HAYES SOLOWAY P.C., 3450 E. SUNRISE DRIVE, SUITE 140, TUCSON, AZ, 85718, US

(21) Appl. No.: 12/675,948

(22) PCT Filed: Aug. 20, 2008
(86) PCT No.: PCT/EP2008/006848

§ 371 Date: Mar. 1, 2010

(30) Foreign Application Priority Data
Aug. 30, 2007 (DE) 20 2007 012 123.7

(51) Int. Cl. B65G 7/12; A62C 33/00

(52) U.S. Cl. 294/15

(57) ABSTRACT

A handling claw (10) has a clamping section (14, 18; 14, 16) in which a tubular or hose-shaped article can be clamped, and a grip section (16; 18) by which a user can grasp the handling claw.

The present invention relates to a handling claw that serves to handle elongated, tubular or hose-shaped articles, for example marine ropes, pipes, lines and hoses, in particular pressure hoses as are used for firefighting.

Such tubular or hose-shaped articles are hard to handle. They have a certain flexural resistance and they are of so large a diameter that they can not or just barely be clasped with one hand. It is therefore difficult to pull such articles, in particular in the longitudinal direction, since the forces necessary therefor can be transferred to the articles only with great effort. In addition, these articles have to be handled sometimes under unfavorable conditions, for example when it is damp or cold, making it even more difficult to more them. In the case of hoses used for firefighting, there is, in addition, the repulse of a fire-extinguishing nozzle that has to be absorbed by the firefighter.

The object of the present invention consists in providing a tool which allows such tubular or hose-shaped articles to be handled more easily.

To achieve this object, according to the invention provision is made for a handling claw including a clamping section in which a tubular or hose-shaped article can be clamped, and a grip section by which a user can grasp the handling claw. The invention is based on the fundamental idea of placing a bow-like handle onto the article to be moved, the handle being automatically clamped on the article and being safely held there when it is being pulled on. The handling claw here takes advantage of the characteristic feature of the tubular or hose-shaped articles that they are comparatively resistant to bending.

According to a preferred embodiment of the invention, the handling claw includes a base body which, in a side view, has the shape of an “E”. As an alternative, provision may be made for the handling claw to have the basic shape of an “S”. These geometric shapes allow the handling claw to be employed in a simple manner in the case of different diameters of the article to be handled. To this end, provision may be made that the distance from an outer bow of the base body to the middle bow differs from the distance of the other outer bow to the middle bow. Depending on its diameter, the article to be handled is thus always clamped between one of the outer bows and the middle bow; the other outer bow then serves as a grip section.

If the handling claw is used for pressure hoses, the distances between the outer bows and the middle section are preferably dimensioned such that the two most frequently used pressure hoses can be clamped, namely on the one hand a so-called C pressure hose and on the other hand a so-called B pressure hose.

According to a preferred embodiment of the invention, provision is made that at least one of the bows of the base body is coated with a plastic, rubber or a similar material. This coating increases friction so that, for one thing, the article to be handled is held even more reliably in the clamping section and, for another thing, the respective user can better hold the grip section.

According to a preferred embodiment of the invention, provision is made that each of the two outer bows are slightly curved. This results in a centering of the article to be handled between the outer bow and the middle bow, so that the handling claw can not slip off.

According to a preferred embodiment, provision is made for a fastening eye which can be used for fastening the handling claw to a tool belt or firefighter's belt, for example, so that in action the handling claw is ready to hand at any time.

Advantageous further configurations of the invention are apparent from the dependent claims.

The invention will be described below with reference to an embodiment that is illustrated in the enclosed drawings, in which:

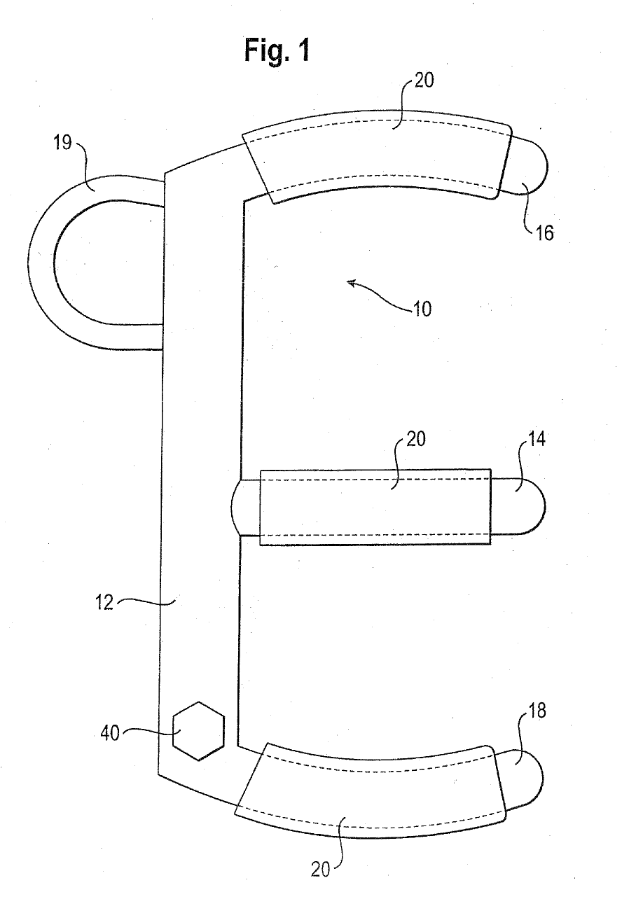

FIG. 1 shows a handling claw in a side view; and

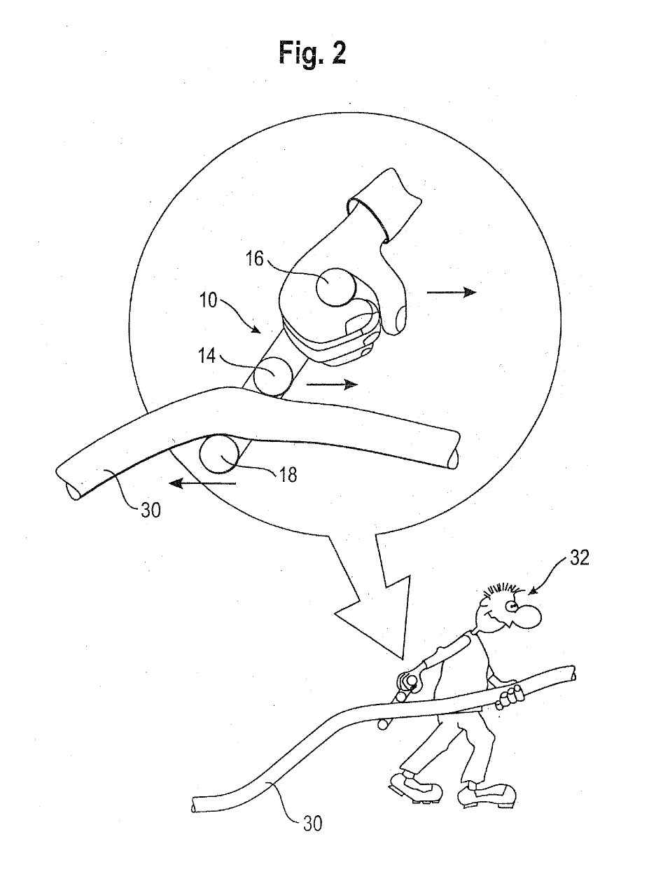

FIG. 2 shows a handling claw in use.

FIG. 1 shows a handling claw 10 which has an E-shaped base body. Due to its geometric shape, the base body includes a side web 12, a middle bow 14, and two outer bows 16, 18. The base body is preferably made of metal, in particular an aluminum alloy, and has a diameter on the order of 20 mm for the side web 12 and a diameter on the order of 15 mm for the bows. Provided on the base body is a fastening eye 19 having a diameter that is adjusted to a usual firefighter's belt. Furthermore provided on the base body is a tool 40, in this case a hexagon wrench, to allow a multifunctional use of the handling claw. The tool could be fitted so as to project outwards from the base body, similar to the fastening eye, to provide a hexagon wrench, for example, having dimensions that are larger than the diameter of the base body.

As can be seen in FIG. 1, the middle bow 14 is of a straight design while the two outer bows 16, 18 are slightly curved such that they appear to be concave as viewed from the middle bow 14. The two outer bows 16, 18 and the middle bow 14 are each provided with a coating 20 which consists of plastic, rubber or a similar material having a coefficient of friction higher than that of metal.

According to an alternative embodiment, not illustrated, the base body 10 may also have an S-shaped form. In this case, too, the two outer bows and a middle bow would be produced.

FIG. 2 shows the handling claw 10 in use. In the illustrated example, it serves to handle a pressure hose 30 utilized by a firefighter 32. The firefighter 32 here uses the one outer bow 16 as a grip section and clamps the pressure hose 30 between the middle bow 14 and the other outer bow 18. As soon as he pulls on the grip section, that is, on the outer bow 16, towards the right (with reference to FIG. 2), the handling claw gets jammed on the pressure hose, so that the other outer bow 18 and the middle bow 14 act as a clamping section in which the pressure hose 30 is reliably clamped. This is assisted by the slight curvature of the outer bow and by the coatings 20.

The handling claw here takes advantage of the fact that the pressure hose is very resistant to bending when the water for firefighting is supplied into it.

The clearance between the middle bow 14 and the outer bow 18 may be preferably on the order of 53 mm, so that the clamping section formed by the two bows 14, 18 is adjusted to a so-called C pressure hose. The clearance between the outer bow 16 and the middle bow 14 is preferably on the order of 76 mm and is therefore adjusted to a so-called B pressure hose.

Now, when a firefighter wishes to use the handling claw to hold or carry a B pressure hose, rather than the C pressure hose as is shown in FIG. 2, he will simply turn the handling claw around so that the outer bow 18 serves as the grip section and the bows 14, 16 constitute the clamping section.

The handling claw may be generally made use of for all tubular or hose-shaped articles that have a certain bending resistance. Examples thereof include tubing, cables and piping used in road construction, building and industrial construction (water pipes, electric power lines, etc.) or marine ropes.

The special advantage of the handling claw resides, for one thing, in its particularly simple structure and the ease of using it resulting therefrom and, for another thing, in the fact that it constitutes a handle that is good to keep hold of, on the article to be handled. This handle is very much better to hold than the article itself, so that by means of the handling claw, very high forces can be applied along the longitudinal direction of the article. In this way, a heavy cable can be pulled, or, in the case of a fire hose, the repulse of a fire-extinguishing nozzle can be countered well.

1. A handling claw comprising a clamping section in which a tubular or hose-shaped article can be clamped, and a grip section by which a user can grasp the handling claw.

2. The handling claw according to claim 1, wherein it includes a base body which, in a side view, has the shape of an “E”.

3. The handling claw according to claim 1, wherein it includes a base body which, in a side view, has the shape of an “S”.

4. The handling claw according to claim 1, wherein the distance from an outer bow of the base body to the middle bow differs from the distance of the other outer bow to the middle bow.

5. The handling claw according to claim 4, wherein the one distance is dimensioned such that a “C pressure hose” can be clamped between the appropriate outer bow and the middle bow, and that the other distance is dimensioned such that a “B pressure hose” can be clamped between the other outer bow and the middle bow.

6. The handling claw according to claim 4, wherein the two outer bows are slightly curved.

7. The handling claw according to claim 2, wherein at least one of the bows of the base body is coated with a plastic, rubber or a similar material.

8. The handling claw according to claim 1, wherein provision is made for a fastening eye.

9. The handling claw according to claim 1, wherein a tool, for example a hexagon wrench, is integrated in the base body.

10. The handling claw according to claim 5, wherein the two outer bows are slightly curved.

11. The handling claw according to claim 3, wherein at least one of the bows of the base body is coated with a plastic, rubber or a similar material.

12. The handling claw according to claim 4, wherein at least one of the bows of the base body is coated with a plastic, rubber or a similar material.

13. The handling claw according to claim 5, wherein at least one of the bows of the base body is coated with a plastic, rubber or a similar material.

14. The handling claw according to claim 6, wherein at least one of the bows of the base body is coated with a plastic, rubber or a similar material.
